(19) United States
(12) Patent Application Publication
(10) Pub. No.: US 2016/0101759 A1
(43) Pub. Date: Apr. 14, 2016

(54) VEHICLE FAR SIDE AIRBAG DEVICE

(71) Applicant: TOYOTA JIDOSHA KABUSHIKI KAISHA, Toyota-shi (JP)

(72) Inventor: Yusuke FUJIWARA, Toyota-shi (JP)

(21) Appl. No.: 14/844,785

(22) Filed: Sep. 3, 2015

(30) Foreign Application Priority Data
Oct. 10, 2014 (JP) 2014-209120

(51) Int. Cl. B60R 21/261; B60R 21/231; B60R 21/235; B60R 21/207

(52) U.S. Cl. CPC B60R 21/261; B60R 21/207; B60R 21/23138; B60R 21/235; B60R 2021/23146; B60R 2021/23576

(57) ABSTRACT

A vehicle far side airbag device that includes: a gas generator that is housed inside a bag body at a bag body diagonally rear lower side with respect to a non-inflation section, and that generates gas on operation; a rear gas flow-path that is formed at the bag body between a rear edge of the non-inflation section and a rear edge of the bag body and that is positioned at a bag body upper side with respect to the gas generator; and a lower gas flow-path that is formed at the bag body between a lower edge of the non-inflation section and a lower edge of the bag body, that is positioned at a bag body front side with respect to the gas generator, and that is set with a larger minimum cross-section area than the rear gas flow-path.

### CROSS-REFERENCE TO RELATED APPLICATION

This application is based on and claims priority under 35 USC 119 from Japanese Patent Application No. 2014-209120 filed on Oct. 10, 2014, which is incorporated by reference herein.

### BACKGROUND

1. Technical Field

The present invention relates to a vehicle far side airbag device including a bag body that inflates and deploys from a side section at a vehicle width direction center side of a seatback of a vehicle seat.

2. Related Art

In an airbag device (side airbag device) described in Japanese Patent Application Laid-Open (JP-A) No. 2012-051557, an airbag bag body includes an inflation location that inflates on receiving gas supplied from an inflator, and a non-inflation location. An opening is formed to the non-inflation location, and a tether inserted through the opening is connected to a rear end portion and a front end portion of the airbag bag body. A deployment trajectory of the airbag bag body is controlled by the tether.

However, the structure of the side airbag device described above is such that the airbag bag body is set with a large vehicle height dimension, and an upper section of the airbag bag body, for protecting the head of an occupant, is not directly fixed to a seatback. There is accordingly a possibility that the upper section of the airbag bag body sways greatly during inflation and deployment in cases in which a flow of gas ejected from the inflator inside the airbag bag body is not well controlled. There is accordingly room for improvement from the perspective of improving head protection performance.

In consideration of the above circumstances, an object of the present disclosure is to obtain a vehicle far side airbag device that contributes to improving head protection performance.

### SUMMARY

A vehicle far side airbag device of a first aspect includes: a bag body that is provided to a side section at a vehicle width direction center side of a seatback of a vehicle seat, that inflates and deploys on being supplied with gas, and that protects an occupant from the head to the abdominal region; a non-inflation section that is formed to a center side of the bag body in a side view and that faces the shoulder region of the occupant in an inflated and deployed state of the bag body; a gas generator that is housed inside the bag body at a bag body diagonally rear lower side with respect to the non-inflation section, and that generates gas on operation; a rear gas flow-path that is formed to the bag body between a rear edge of the non-inflation section and a rear edge of the bag body and that is positioned at a bag body upper side with respect to the gas generator; and a lower gas flow-path that is formed to the bag body between a lower edge of the non-inflation section and a lower edge of the bag body, that is positioned at a bag body front side with respect to the gas generator, and that is set with a larger minimum cross-section area than the rear gas flow-path.

In the first aspect, the bag body that protects an occupant from the head to the abdominal region is provided to the side section at the vehicle width direction center side of the seatback of the vehicle seat. The non-inflation section is formed to the center side of the bag body in side view, and the gas generator is housed inside the bag body at the bag body diagonally rear lower side with respect to the non-inflation section. The gas generator operates to generate gas during a side-on collision of the vehicle, for example. Part of the gas generated by the gas generator passes through the rear gas flow-path, formed to the bag body between the rear edge of the non-inflation section and the rear edge of the bag body and positioned at the bag body upper side with respect to the gas generator, and is supplied to a rear portion side of an upper section of the bag body. Part of the gas generated by the gas generator passes through the lower gas flow-path, formed to the bag body between the lower edge of the non-inflation section and the lower edge of the bag body and positioned at the bag body front side with respect to the gas generator, and is supplied to a front portion side of a lower section of the bag body.

The lower gas flow-path is set with a larger minimum cross-section area than the rear gas flow-path. Thus, a flow rate of gas supplied to the front portion side of the lower section of the bag body through the lower gas flow-path (hereafter referred to as “lower path gas”) can be set higher than a flow rate of gas supplied to the rear portion side of the upper section of the bag body through the rear gas flow-path (hereafter referred to as “upper path gas”). Part of the greater supply of lower path gas to the front portion side of the lower section of the bag body passes between a front end of the non-inflation section and a front edge of the bag body, and is supplied to a front portion side of the upper section of the bag body. Namely, since gas is supplied to the upper section of the bag body along two paths, the upper section of the bag body, namely, a location protecting the head of the occupant, can be stably inflated and deployed from bottom to top by a good balance between the flow rates of gas along the two flow paths. This contributes to improving head protection performance.

A vehicle far side airbag device of a second aspect is the first aspect, wherein the gas generator includes an inflator and a diffuser, and the diffuser is formed in a tube shape expanding in diameter on progression from an upper end opening toward a lower end opening of the diffuser, and houses the inflator inside.

In the second aspect, gas generated by the inflator is supplied to the rear gas flow-path side from the upper end opening of the diffuser, and supplied to the lower gas flow-path side from the lower end opening of the diffuser. Since the diffuser is formed in a tube shape expanding in diameter on progression from the upper end opening toward the lower end opening, the flow rate of gas supplied to the lower gas flow-path side from the lower end opening can be made higher than the flow rate of gas supplied to the rear gas flow-path side from the upper end opening. This enables the difference in flow rates between the lower path gas and the upper path gas described above to be effectively increased.

A vehicle far side airbag device of a third aspect is the first aspect or the second aspect, wherein the gas generator includes an inflator, and the inflator generates gas from a gas generation portion provided to a lower end portion of the inflator.

In the third aspect, since the gas generation portion of the inflator is provided to the lower end portion of the inflator, the gas generation portion can be disposed nearer to the lower gas flow-path than the rear gas flow-path. Since more gas generated by the gas generation portion can accordingly made to flow toward the lower gas flow-path side, the difference in flow rates between the lower path gas and the upper path gas described above can be effectively increased.

A vehicle far side airbag device of a fourth aspect is any one of the first aspect to the third aspect, wherein in a side view of the bag body in the inflated and deployed state, the rear gas flow-path is formed with a minimum cross-section area further toward the vehicle lower side than a horizontal line passing through the center of the shoulder region of the occupant and extending along the vehicle front-rear direction.

In the fourth aspect, the rear gas flow-path formed to the bag body is formed as described above. Note that a bag body for occupant protection installed to a seatback of a vehicle seat is generally housed inside the seatback in a folded, packaged state. An upper end portion of the package is set, for example, at the same height as the horizontal line described above. Configuration as in the present disclosure thereby enables the bag body to be configured such that no fold is set in the vicinity of a minimum cross-section portion of the rear gas flow-path during the packaging described above. It is accordingly not difficult for gas from the gas generator to pass through the rear gas flow-path during initial operation of the gas generator.

A vehicle far side airbag device of a fifth aspect is any one of the first aspect to the fourth aspect, wherein in a side view of the bag body in the inflated and deployed state, the lower gas flow-path is formed with a minimum cross-section area further toward the vehicle rear side than a torso line of the occupant.

In the fifth aspect, the lower gas flow-path formed to the bag body is configured as described above. Since the lower gas flow-path is formed at the lower edge side of the bag body that protects an occupant from the head to the abdominal region, the lower gas flow-path is disposed at the same height as the abdominal region of the occupant on inflation and deployment of the bag body. Moreover, a location of a front edge portion (frame portion) of a side support section provided to the side section of the seatback, positioned at the same height as the abdominal region of the occupant, for example, is set in the vicinity of the torso line of the occupant in side view.

Configuration as in the present invention thereby enables a minimum cross-section portion of the lower gas flow-path in the bag body to be prevented from projecting out from the frame portion toward the vehicle front side during inflation and deployment of the bag body. Since the minimum cross-section portion of the lower gas flow-path may be considered as a housing section of the gas generator in the bag body, namely, a gas ejection port from a location with high pressure during operation of the gas generator, the configuration of the present invention enables this high pressure location to be prevented from projecting out toward the vehicle front side from the frame portion. Thus even if, for example, the bag body is inflated and deployed in a state in which the head of a child or the like is present in an unsuitable position (out of position) toward the vehicle front of the side support section, a contribution is made to reducing load borne by the head of the child or the like.

### BRIEF DESCRIPTION OF DRAWINGS

FIG. 1 is a side view of a vehicle seat installed with a vehicle far side airbag device according to an exemplary embodiment of the present disclosure, illustrating an airbag in an inflated and deployed state;

FIG. 2 is a side view illustrating an enlarged portion of FIG. 1;

FIG. 3 is a perspective view of a diffuser included in the vehicle far side airbag device;

FIG. 4 is a perspective view corresponding to FIG. 3, for explaining a modified example of the diffuser; and

FIG. 5 is a side view corresponding to a portion of FIG. 1, for explaining a modified example of a non-inflation section, and a modified example of placement of an inflator.

### DESCRIPTION OF EMBODIMENTS

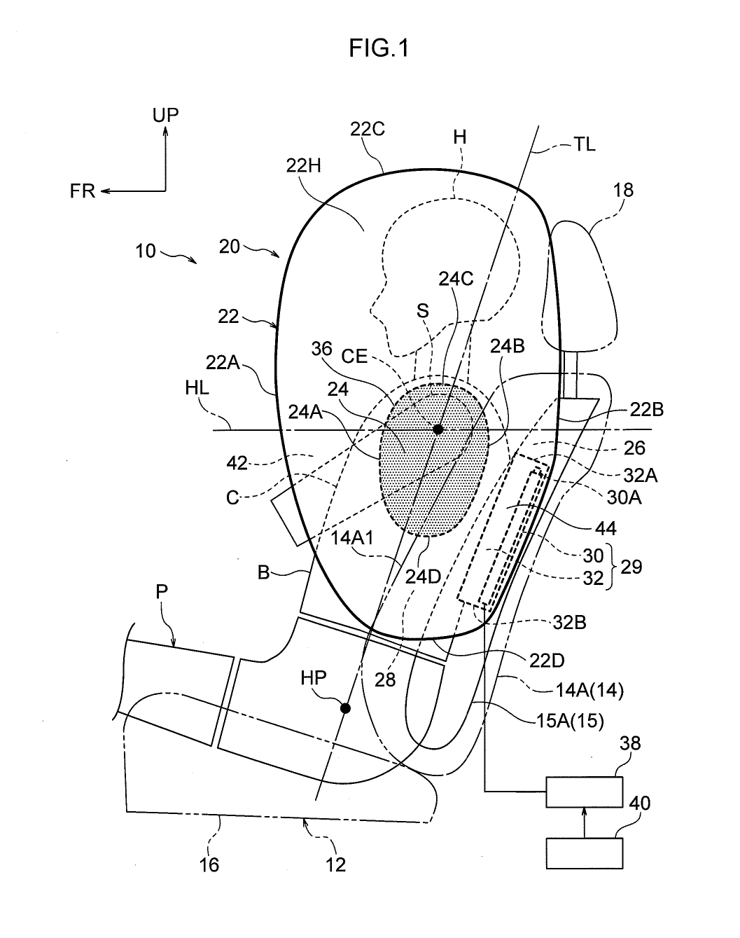

Explanation follows regarding a vehicle far side airbag device 10 according to an exemplary embodiment of the present invention, with reference to FIG. 1 to FIG. 3. Note that in each of the drawings, the arrow FR and the arrow UP respectively indicate the front direction (direction of progress) and the upper direction of a vehicle, as appropriate. Unless specifically stated otherwise, simple reference below to the front-rear, left-right, and up-down directions refers to front-rear in the vehicle front-rear direction, left-right in the vehicle left-right direction (vehicle width direction), and up-down in the vehicle up-down direction.

Configuration

The vehicle far side airbag device 10 illustrated in FIG. 1 is installed to a vehicle center-side side support section 14A (vehicle width direction center-side side section, hereafter simply referred to as “center-side side support section 14A”) of a seatback 14 of a vehicle seat 12. The vehicle seat 12 is, for example, a driving seat in a right-hand drive vehicle. The seatback 14 of the vehicle seat 12 is reclinably coupled to a rear end section of a seat cushion 16, and an upper end section of the seatback 14 is coupled to a headrest 18.

Note that in the present exemplary embodiment, the front-rear direction, left-right direction (width direction), and up-down direction of the vehicle seat 12 are aligned with the front-rear direction, left-right direction, and up-down direction of the vehicle. In FIG. 1, a crash test dummy P is illustrated seated in the vehicle seat 12 instead of an actual occupant. The dummy P is, for example, a World Side Impact Dummy (World SID) of AM50 (an American adult male in the 50^{th} percentile). The dummy D is seated in a standard seated posture specified in collision testing methods. A front-rear position of the seat cushion 16 with respect to the vehicle, and a slope position (slope angle) of the seatback 14 with respect to the seat cushion 16 are adjusted to reference set positions corresponding to the seated posture. In order to facilitate understanding of the explanation, the dummy P is hereafter referred to as “occupant P”.

The vehicle far side airbag device 10 is a device mainly for protecting an occupant at the opposite side to a collision side in the event of a side-on collision of the vehicle, and includes an airbag 20 (far side airbag) installed at the center-side side support section 14A. The airbag 20 is configured with a bag body 22 as a relevant portion. The bag body 22 is formed with a non-inflation section 24, a rear gas flow-path 26, a lower gas flow-path 28, and the like. A gas generator 29, configured by an inflator 30 and a diffuser 32, is housed inside the bag body 22.

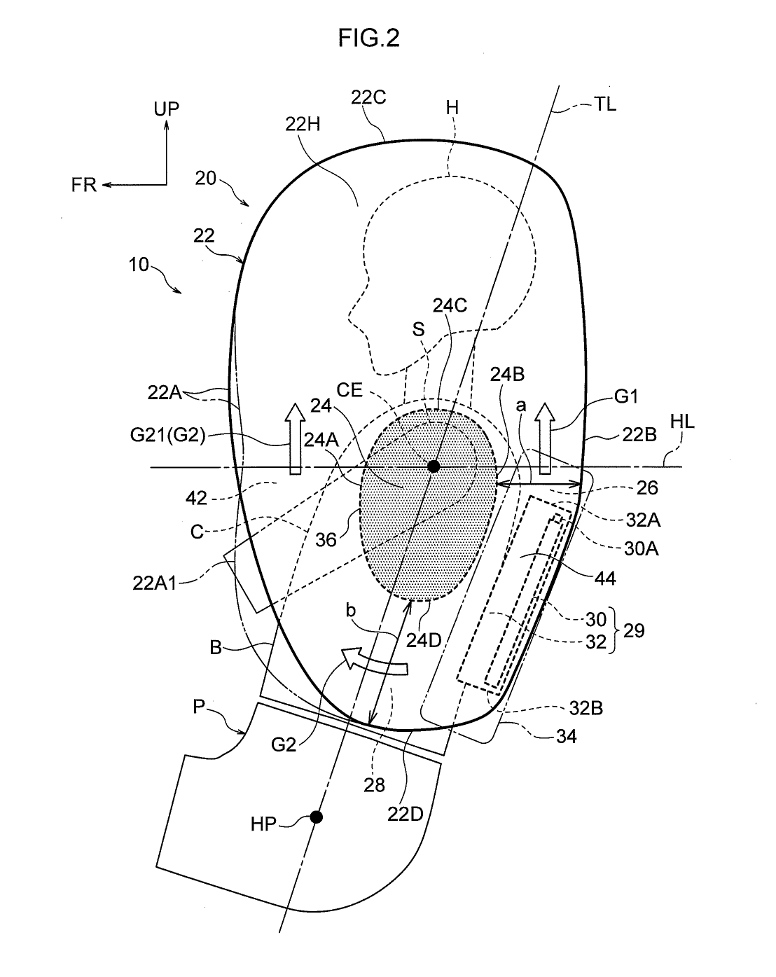

The bag body 22 configures a module together with the inflator 30 and the diffuser 32, and is normally housed inside the center-side side support section 14A in a folded state configured as an elongated rectangular box shaped package 34 (see FIG. 2). The package 34 is disposed with its length direction oriented along the up-down direction of the seatback 14.

The bag body 22 inflates and deploys toward the vehicle width direction center side of the occupant P (the front side of the center-side side support section 14A) due to pressure from gas generated by the inflator 30 (the state illustrated in FIG. 1). A seatback pad and a seat cover installed to the center-side side support section 14A are configured so as to rupture under inflation pressure of the bag body 22 during inflation and deployment. Note that unless specifically stated otherwise, the front-rear and up-down directions of the bag body 22 described in the below explanation refer to the directions of the bag body 22 in an inflated and deployed state, and are substantially aligned with the front-rear and up-down directions of the vehicle.

The bag body 22 is formed in an elongated bag shape by folding a single base cloth in two, formed by cutting out a cloth material made of nylon thread or polyester thread, for example, and stitching together outer peripheral edge portions of the folded base cloth. When viewed from the side of a side face (the vehicle width direction center side in this example) in the inflated and deployed state illustrated in FIG. 1, the bag body 22 is formed in an elongated, substantially oval shape (a substantially elliptical shape) along the vehicle up-down direction, capable of protecting (restraining) the occupant P from the head H to the abdominal region B. Note that FIG. 1 illustrates a state directly before the bag body 22 restrains the occupant P from the head H to the abdominal region B (a non-restraining inflated and deployed state, hereafter simply referred to as “inflated and deployed state”). The shape of the bag body 22 is not limited to the shape illustrated in FIG. 1, and may be changed as appropriate. A front end lower portion of the bag body 22 may, for example, be configured in the shape illustrated by the double-dotted dashed line in FIG. 2.

The non-inflation section 24 is formed to a center side of the bag body 22 in side view. Note that in FIG. 1 and FIG. 2, dots are applied to a region corresponding to the non-inflation section 24 in order to make the non-inflation section 24 more visible. The non-inflation section 24 is formed by stitching the base cloth of the bag body 22 at an upright-long-axis substantially oval shaped (substantially elliptical shaped) stitch portion 36 set at the center side of the bag body 22. The non-inflation section 24 is enclosed by the stitch portion 36, such that gas from the inflator 30 is not supplied into the non-inflation section 24. Thus the non-inflation section 24 does not inflate on operation of the inflator 30, and an inflation section set at the periphery of the non-inflation section 24 is configured to inflate in a donut shape.

The non-inflation section 24 is formed such that its center is positioned slightly toward the lower side (a lower edge 22D side) of the bag body 22 than the center of the bag body 22, and is formed slightly toward the lower edge 22D of the bag body 22. As illustrated in FIG. 1 and FIG. 2, in the inflated and deployed state of the bag body 22, an upper portion of the non-inflation section 24 is configured so as to face a shoulder region S of the occupant P from the vehicle width direction center side. A location of the bag body 22 further toward the upper side (upper end side) than the non-inflation section 24 configures a head protection section 22H for protecting the head H of the occupant P.

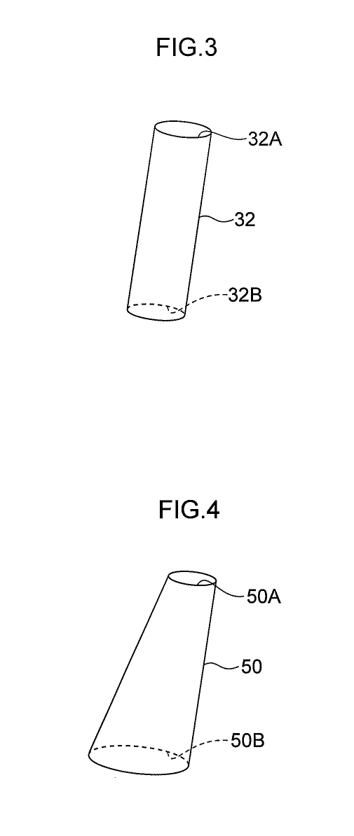

The diffuser 32 and the inflator 30 are housed inside the bag body 22 at the bag body 22 diagonally lower rear side with respect to the non-inflation section 24. The diffuser 32 is a member referred to as a loop diffuser, an inner tube, a regulating cloth, or the like, and is formed by stitching a base cloth, formed by cutting a similar cloth material to the base cloth of the bag body 22 into a rectangular shape, into a straight circular tube shape (see FIG. 3). The diffuser 32 is installed at a rear end portion of a lower section inside the bag body 22, oriented with its axial line direction along the up-down direction of the seatback 14. The diffuser 32 is set with the same diameter from an upper end to a lower end thereof, and an upper end opening 32A formed at the upper end, and a lower end opening 32B formed at the lower end of the diffuser 32 are set with the same opening surface area. The diffuser 32 has a function to distribute gas generated by the inflator 30 up and down.

The inflator 30 is what is referred to as a cylinder type gas generator, and is formed in a circular tube shape. The inflator 30 is set with an axial line direction dimension that is slightly shorter than the diffuser 32, and is housed inside the diffuser 32 oriented with its axial line direction along the axial line direction of the diffuser 32. A pair of upper and lower stud bolts project out from an outer peripheral portion of the inflator 30 toward the vehicle width direction outside. The stud bolts pierce through the base cloth of the bag body 22, the base cloth of the diffuser 32, and a side frame 15A of a seatback frame 15, and nuts are screwed onto leading end sides of the stud bolts. The inflator 30 is accordingly fastened and fixed to the seatback frame 15 together with the bag body 22 and the diffuser 32.

As illustrated in FIG. 1, the inflator 30 is electrically connected to an ECU 38 (controller) installed to the vehicle. A side collision sensor 40 that detects a side-on collision of the vehicle is electrically connected to the ECU 38. The ECU 38 and the side collision sensor 40 are configuration members of the vehicle far side airbag device 10.

The ECU 38 is configured to operate (actuate) the inflator 30 when (the inevitability of) a side-on collision of the vehicle has been detected based on a signal from the side collision sensor 40. Specifically, since the vehicle far side airbag device 10 according to the present exemplary embodiment is installed to the vehicle seat 12 that is the driving seat in a right-hand drive vehicle, the inflator 30 is actuated when the ECU 38 detects that another vehicle has collided with a side section (left side section) at a front passenger seat side of the vehicle. On actuation of the inflator 30, gas is ejected in a radial shape from a gas ejection portion (gas generation portion) 30A provided to one of either an upper end portion or a lower end portion (the upper end portion in this example) of the inflator 30. Note that, in cases in which a pre-crash sensor that predicts (forecasts) a side-on collision is electrically connected to the ECU 38, the inflator 30 may be configured to be actuated when the ECU 38 has predicted a side-on collision based on a signal from the pre-crash sensor.

The inflator 30 and the diffuser 32 described above are installed between the rear gas flow-path 26 and the lower gas flow-path 28 formed to the bag body 22. The rear gas flow-path 26 is formed to the bag body 22 between a rear edge 24B of the non-inflation section 24 and a rear edge 22B of the bag body 22, and is positioned at the bag body 22 upper side with respect to the inflator 30 and the diffuser 32. The lower gas flow-path 28 is formed to the bag body 22 between a lower edge 24D of the non-inflation section 24 and the lower edge 22D of the bag body 22, and is positioned at the bag body 22 front side (a front edge 22A side, specifically, the diagonally lower front side) with respect to the inflator 30 and the diffuser 32. Note that a front gas flow-path 42 is formed to the bag body 22 between a front edge 24A of the non-inflation section 24 and the front edge 22A of the bag body 22. In FIG. 1 and FIG. 2, the reference numeral 22C is applied to an upper edge of the bag body 22, and the reference numeral 24C is applied to an upper edge of the non-inflation section 24.

A location of the bag body 22 between the rear gas flow-path 26 and the lower gas flow-path 28 configures a gas generator housing section 44 that houses the inflator 30 and the diffuser 32, namely, the gas generator 29. In side view of the bag body 22 in the inflated and deployed state, the rear gas flow-path 26 is formed such that its cross-section area (a flow path cross-section area, the same applies below) is at a minimum further toward the vehicle lower side than a horizontal line (vehicle front-rear direction line) HL passing through the shoulder region S of the occupant P and extending along the vehicle front-rear direction. In the side view, the lower gas flow-path 28 is formed such that its cross-section area is at a minimum further toward the vehicle rear side than a torso line TL of the occupant P.

The minimum cross-section area of the lower gas flow-path 28 is set larger than the minimum cross-section area of the rear gas flow-path 26. In the present exemplary embodiment, a dimension b is set larger than a dimension a illustrated in FIG. 2. In the side view illustrated in FIG. 2, the dimension a represents a flow-path diameter of the rear gas flow-path 26 along the horizontal line HL. In the side view illustrated in FIG. 2, the dimension b represents a flow-path diameter of the lower gas flow-path 28 along the torso line TL

In side view of the occupant P, the torso line TL is a hypothetical line passing through a center CE of the shoulder region S of the occupant P (an axial center of a bolt provided to the shoulder region S of the dummy P in this example), and a hip point HP of the occupant P. As illustrated in the side view in FIG. 1, in the present exemplary embodiment, a location of a frame portion 14A1, this being a front edge portion of the center-side side support section 14A, positioned at the same height as the lower gas flow-path 28 (a location positioned at the same height as the abdominal region B of the occupant P) is set so as to extend along the up-down direction of the seatback 14 in the vicinity of the torso line TL.

In the present exemplary embodiment, an upper end portion of the package 34 illustrated in FIG. 2 is set so as to be positioned at the same height as the horizontal line HL and further toward the vehicle upper side than the upper end opening 32A of the diffuser 32. Moreover, in the present exemplary embodiment, a lower end portion of the package 34 illustrated in FIG. 2 is set so as to be positioned further toward the vehicle lower side than the lower end opening 32B of the diffuser 32.

### OPERATION AND ADVANTAGEOUS EFFECTS

Explanation follows regarding operation and advantageous effects of the present exemplary embodiment.

In the vehicle far side airbag device 10 configured as described above, when the ECU 38 detects a side-on collision based on a signal from the side collision sensor 40, the inflator 30 is actuated by the ECU 38, and gas is ejected from the gas ejection portion 30A of the inflator 30. Part of the gas ejected from the gas ejection portion 30A is ejected from the upper end opening 32A of the diffuser 32 toward the upper side of the bag body 22, and is supplied to a rear portion side of an upper section of the bag body 22 through the rear gas flow-path 26 (see the arrow G1 in FIG. 2). Moreover, part of the gas ejected from the gas ejection portion 30A is ejected from the lower end opening 32B of the diffuser 32 toward the lower side of the bag body 22, and is supplied to a front portion side of the lower section of the bag body 22 through the lower gas flow-path 28 (see the arrow G2 in FIG. 2).

The minimum cross-section area of the lower gas flow-path 28 is set larger than that of the rear gas flow-path 26. Thus a flow rate of gas G2 supplied to a front portion side of the lower section of the bag body 22 through the lower gas flow-path 28 (hereafter referred to as “lower path gas G2”) can be set higher than a flow rate of gas G1 supplied to the rear portion side of the upper section of the bag body 22 through the rear gas flow-path 26 (hereafter referred to as “upper path gas G1”). Part of the greater supply of lower path gas G2 to the front portion side of the lower section of the bag body 22 is supplied to a front portion side of the upper section of the bag body 22 through the front gas flow-path 42 (see the arrow G21 in FIG. 2). Namely, since gas is supplied to the upper section of the bag body 22 along two paths, the upper section of the bag body 22, namely, the head protection section 22H, can be stably inflated and deployed from bottom to top by a good balance between the flow rates of gas along the two flow paths. This enables deployment behavior of the head protection section 22H to be stabilized, thus contributing to improving head protection performance.

In the present exemplary embodiment, the gas ejection portion 30A is provided to the upper end portion of the inflator 30, that is nearer to the rear gas flow-path 26 than to the lower gas flow-path 28. Moreover, the upper end opening 32A and the lower end opening 32B of the diffuser 32, that distribute gas ejected from the gas ejection portion 30A up and down, are set with the same opening surface area. These points are conditions such that gas is more liable to flow toward the rear gas flow-path 26 side than toward the lower gas flow-path 28 side; however, more gas can be made to flow toward the lower gas flow-path 28 side by adjusting the minimum cross-section areas of the rear gas flow-path 26 and the lower gas flow-path 28 as appropriate. Namely, the present exemplary embodiment enables the advantageous effects described above to be obtained, regardless of the up-down position of the gas ejection portion 30A of the inflator 30, or the shape and presence of the diffuser 32. By forming the diffuser 32 in a straight circular tube shape as in the present exemplary embodiment, yield of the base cloth of the diffuser 32 can be improved. Furthermore, the airbag 20 has a simple configuration in which only the non-inflation section 24 is formed to the center side of the bag body 22. This contributes to reducing manufacturing cost.

In the present exemplary embodiment, in the side view of the bag body 22 in the inflated and deployed state, the rear gas flow-path 26 is formed with its minimum cross-section area further toward the vehicle lower side than the horizontal line HL passing through the shoulder region S of the occupant P and extending along the vehicle front-rear direction. Moreover, in the present exemplary embodiment, the upper end portion of the package 34 illustrated in FIG. 2 is set at the same height as the horizontal line HL. Thus, when the bag body 22, configured as a module together with the inflator 30 and the diffuser 32, is folded to form the package 34 (when being packaged), configuration can be made such that no fold is set in the bag body 22 in the vicinity of a minimum cross-section portion of the rear gas flow-path 26. This contributes to it accordingly not being difficult for gas from the inflator 30 to pass through the rear gas flow-path 26 during initial operation of the inflator 30.

In the present exemplary embodiment, since the upper end opening 32A of the diffuser 32 is set further toward the vehicle lower side than the rear gas flow-path 26, configuration can be made such that no fold is set in the vicinity of the upper end opening 32A of the diffuser 32 during the packaging described above. This enables gas from the inflator 30 to be smoothly ejected from the upper end opening 32A toward the rear gas flow-path 26 side during initial operation of the inflator 30.

In the present exemplary embodiment, in the side view of the bag body 22 in the inflated and deployed state, the lower gas flow-path 28 is formed with its minimum cross-section area further toward the vehicle rear side than the torso line TL of the occupant P. The lower gas flow-path 28 is formed at the lower edge 22D side of the bag body 22, and is disposed at the same height as the abdominal region B of the occupant P when the bag body 22 is inflated and deployed. A location of the frame portion 14A1 of the center-side side support section 14A of the seatback 14, positioned at the same height as the abdominal region B of the occupant P, is set in the vicinity of the torso line TL of the occupant P in side view.

This enables a minimum cross-section portion of the lower gas flow-path 28 in the bag body 22 to be prevented from projecting out from the frame portion 14A1 toward the vehicle front side during inflation and deployment of the bag body 22. Since the minimum cross-section portion of the lower gas flow-path 28 may be considered as a gas ejection port of the bag body 22 from the gas generator housing section 44 (namely, a location with high pressure during operation of the inflator 30), the configuration of the present exemplary embodiment enables this high pressure location to be prevented from projecting out from the frame portion 14A1 toward the vehicle front side. Thus even if, for example, the bag body 22 is inflated and deployed in a state in which the head of a child or the like is present in an unsuitable position (out-of-position (OOP)) toward the vehicle front of the center-side side support section 14A, load borne by the head of the child or the like can be reduced, thereby contributing to securing what is referred to as OOP performance.

In the present exemplary embodiment, the non-inflation section 24 formed to the center side of the bag body 22 faces the shoulder region S of the occupant P in the inflated and deployed state of the bag body 22. Since the bag body 22 does not inflate at a location at which the non-inflation section 24 is formed, the shoulder region S, this being the part of the body of the occupant P projecting out furthest in the left-right direction, contacts the inflated and deployed bag body 22 first, such that the bag body 22 can be prevented or suppressed from escaping toward the opposite side of the occupant P.

### Supplementary Explanation of Exemplary Embodiment

Note that in the above exemplary embodiment, the diffuser 32 is configured formed in a straight circular tube, shape; however, the present invention is not limited thereto, and the shape of the diffuser 32 may be changed as appropriate. For example, a diffuser 50 may be formed as illustrated in FIG. 4. The diffuser 50 is formed in a tube shape widening in diameter from an upper end opening 50A on progression toward a lower end opening 50B, and is housed inside the inflator 30. The diffuser 50 is formed with a truncated circular cone shaped external profile. In the diffuser 50, a flow rate of gas supplied from the lower end opening 50B toward the lower gas flow-path 28 side can be made higher than a flow rate of gas supplied from the upper end opening 50A toward the rear gas flow-path 26 side. This enables the difference in flow rates between the lower path gas G2 and the upper path gas G1, as explained in the above exemplary embodiment, to be effectively increased.

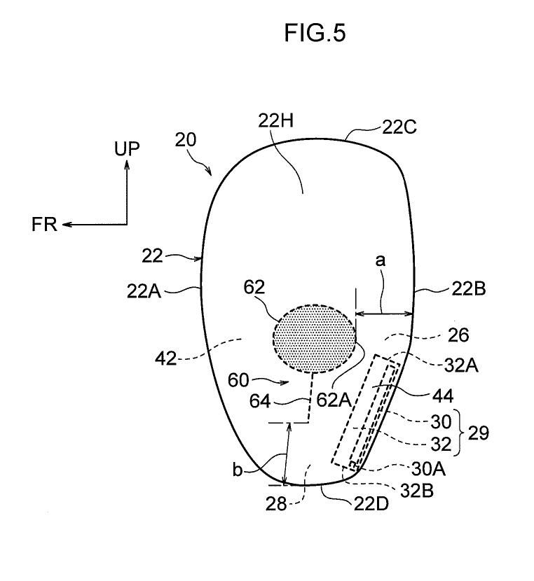

In the above exemplary embodiment, the gas ejection portion 30A of the inflator 30 is configured provided to the upper end portion of the inflator 30; however, the present invention is not limited thereto, and as illustrated in FIG. 5, the gas ejection portion 30A may be configured provided to a lower end portion of the inflator 30. This enables the gas ejection portion 30A to be disposed nearer to the lower gas flow-path 28 than to the rear gas flow-path 26, thus enabling more gas ejected from the gas ejection portion 30A to be made to flow toward the lower gas flow-path 28 side. This enables the difference in flow rates between the lower path gas G2 and the upper path gas G1 previously described to be effectively increased.

In the above exemplary embodiment, the non-inflation section 24 is configured formed by an upright-long-axis substantially oval shaped (substantially elliptical shaped) stitch portion 36; however, the present invention is not limited thereto, and the shape of the non-inflation section 24 may be changed as appropriate. As illustrated in FIG. 5, for example, a non-inflation section 60 may be configured formed of a crosswise-long-axis substantially elliptical shaped stitch portion 62, and a straight line stitch portion 64 extending from a lower end of the stitch portion 62 toward the lower edge 22D side of the bag body 22. The rear gas flow-path 26 is then formed between a rear edge 62A of the stitch portion 62 and the rear edge 22B of the bag body 22, and the lower gas flow-path 28 is formed between a lower end of the stitch portion 64 and the lower edge 22D of the bag body 22.

In the present invention, the shape of the bag body 22 is not limited to the shape illustrated by solid lines in FIG. 1, FIG. 2, and FIG. 5, and may be changed as appropriate. The front edge 22A of the bag body 22, for example, may be configured in the shape illustrated by the double-dotted dashed line in FIG. 2, and a rear sloped portion 22A1, extending diagonally toward the vehicle upper rear on progression from a lower end toward an upper end thereof in the inflated and deployed state of the bag body 22, may be formed to a lower portion of the front edge 22A. Due the lower path gas G2 flowing diagonally toward the vehicle upper rear along the rear sloped portion 22A1, configuration can be made such that an upper portion side of the front edge 22A does not bear force toward the vehicle front side from the lower path gas G2. This further contributes to stabilizing the deployment behavior of the head protection section 22H.

Various other modifications may be implemented within a range not departing from the spirit of the present disclosure. The scope of rights of the present invention is not limited by the above exemplary embodiment.

As explained above, the vehicle far side airbag device of the present disclosure contributes to improving head protection performance.

1. A vehicle far side airbag device comprising:
a bag body that is provided at a side section at a vehicle width direction center side of a seatback of a vehicle seat, that inflates and deploys on being supplied with gas, and that protects an occupant from a head to an abdominal region;
a non-inflation section that is formed at a center side of the bag body in a side view and that faces a shoulder region of the occupant in an inflated and deployed state of the bag body;
a gas generator that is housed inside the bag body at a bag body diagonally rear lower side with respect to the non-inflation section, and that generates gas on operation;
a rear gas flow-path that is formed at the bag body between a rear edge of the non-inflation section and a rear edge of the bag body and that is positioned at a bag body upper side with respect to the gas generator; and
a lower gas flow-path that is formed at the bag body between a lower edge of the non-inflation section and a lower edge of the bag body, that is positioned at a bag body front side with respect to the gas generator, and that is set with a larger minimum cross-section area than the rear gas flow-path.

2. The vehicle far side airbag device of claim 1, wherein:
the gas generator includes an inflator and a diffuser; and
the diffuser is formed in a tube shape, that expands in diameter on progression from an upper end opening toward a lower end opening of the diffuser, and houses the inflator inside.

3. The vehicle far side airbag device of claim 1, wherein:
the gas generator includes an inflator; and
the inflator generates gas from a gas generation portion provided at a lower end portion of the inflator.

4. The vehicle far side airbag device of claim 1, wherein
in a side view of the bag body in the inflated and deployed state, the rear gas flow-path is formed with a minimum cross-section area further toward the vehicle lower side than a horizontal line passing through the center of the shoulder region of the occupant and extending along the vehicle front-rear direction.

5. The vehicle far side airbag device of claim 1, wherein
in a side view of the bag body in the inflated and deployed state, the lower gas flow-path is formed with a minimum cross-section area further toward the vehicle rear side than a torso line of the occupant.

6. The vehicle far side airbag device of claim 1, wherein:
the gas generator includes a diffuser; and
the diffuser is formed in a straight circular tube shape.

7. The vehicle far side airbag device of claim 1, wherein
the non-inflation section is formed by an upright-long-axis elliptical shaped stitch portion.

8. The vehicle far side air bag device of claim 1, wherein
the non-inflation section is formed of a crosswise-long axis substantially elliptical shaped stitch portion and a straight line stitch portion extending from a lower end of the stitch portion toward the lower edge side of the bag body,
the rear gas flow-path is formed between a rear edge of the stitch portion and the rear edge of the bag body, and
the lower gas flow-path is formed between a lower end of the straight line stitch portion and the lower edge of the bag body.
